(19) United States
(12) Patent Application Publication
(10) Pub. No.: US 2021/0261452 A1
(43) Pub. Date: Aug. 26, 2021

(54) SULFATE AND TRACE METAL PRECIPITATION METHODS AND COMPOSITIONS

(71) Applicant: KURITA AMERICA INC., Minneapolis, MN (US)

(72) Inventors: Travis HANSON, Superior, WI (US); Jennifer STARNER, New Hope, MN (US); Paul R. YOUNG, Wheaton, IL (US); Nathan BACH, Saint Michael, MN (US)

(21) Appl. No.: 17/182,202

(22) Filed: Feb. 22, 2021

Related U.S. Application Data
(60) Provisional application No. 62/980,389, filed on Feb. 23, 2020.

(51) Int. Cl. C02F 9/00

(52) U.S. Cl. CPC C02F 9/00; C02F 2101/101

(57) ABSTRACT

The present disclosure relates to methods for treating water or wastewater for sulfate removal and to generate high RCRA 8 metals and sulfate “lockdown” using lime, aluminate, and high residence time and compositions produced by the same.

### CROSS REFERENCE TO RELATED APPLICATIONS

This application claims the benefit of U.S. Provisional Patent Application No. 62/980,389, filed Feb. 23, 2020, which is herein incorporated by reference in its entirety.

### TECHNICAL FIELD

The field of the present disclosure is water and wastewater treatment methods and compositions produced by the same.

### BACKGROUND

Many industrial processes generate wastewater containing high levels of sulfate. Also, some groundwater supplies exceed sulfate drinking water standards. Because sulfate is quite soluble and chemically unreactive, these waters are problematic for reuse or recycling, and difficult to treat before discharging to the environment. Currently available treatments are marginally effective or uneconomical. As a practical matter, current lime softening methods only reduce sulfate concentrations down to about 2000 ppm, which is not low enough for many purposes. For example, some municipal potable water supplies exceed the 250 ppm US Public Health Service guideline for sulfate.

Those processes also include drawbacks such as high capital cost, brine waste streams, excessive sludge, sludge that solidifies to cement, sludge that is classified as hazardous waste, and poor reaction outcomes (e.g., poorly reactive reagents or suspended solids that settle in hours). And, if the metals that were once captured in the sludge readily leach back into the environment, the processes may have little benefit. Accordingly, there exists a need for an effective and economical treatment method to eliminate or greatly reduce sulfate and capture metal contaminates.

### BRIEF DESCRIPTION OF THE DRAWINGS

FIG. 1 is a schematic depicting a sulfate and trace metals precipitation process.

FIG. 2 is a Venn diagram showing ions and metals removed by engineered reagents in the SaltOUT-881, SaltOUT-7510, SaltOUT-751, and SaltOUT-841 processes.

FIG. 3 is a diagram showing a performance overview indicating the % removal of each constituent as indicated following the NaAlO₂ procedure.

FIG. 4 is a schematic overview of an exemplary process flow diagram (PFD) at 100 gallons per minute (gpm) inlet for flue gas desulfurization (FGD) basin treatment or similar applications.

FIG. 5 is a schematic overview of sulfate removal in a single-stage pilot (PFD).

FIG. 6 is a chart showing day 3 performance results quantifying sulfate concentration (ppm) in the single-stage pilot.

FIG. 7 is a chart showing sulfate concentration (ppm) in Stage II from a test run with measurements taken at the indicated time points (x-axis).

FIG. 8 is a table showing various data related to engineered reagent generation.

FIG. 9 is a table showing typical properties of sodium aluminate products from USALCO, a commercial supplier.

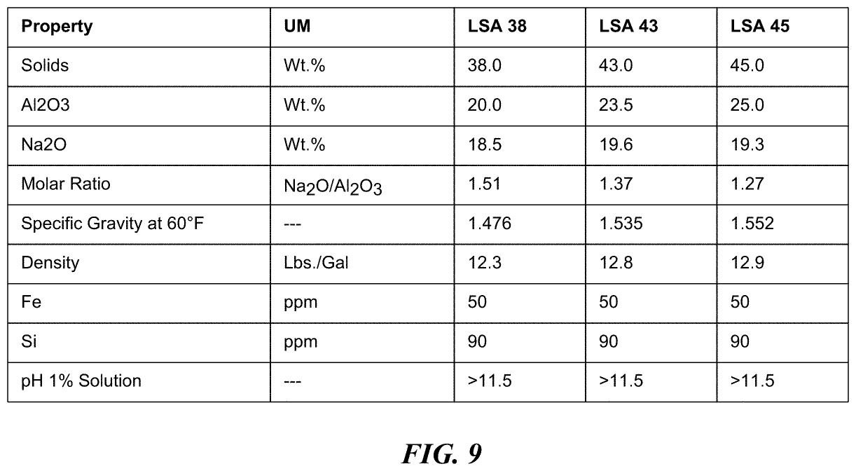

FIG. 10 is a table showing pilot test data.

FIG. 11 is a table showing pilot test data.

### DETAILED DESCRIPTION

### Definitions and Abbreviations

Unless otherwise specified, each of the following terms has the meaning set forth in this section.

The term “Wastewater” refers to materials comprising a plurality of water and also comprising dissolved sulfate, without regard to the particular source of the water or sulfate, and also without regard to additional dissolved or suspended materials that may be present. Non-limiting examples include acid mine drainage, flue gas desulfurization effluent, and spent acid cleaners, but may also include waters naturally high in sulfate.

“Supernatant” is the liquid lying above, or otherwise separated from, a solid residue after crystallization, precipitation, settling, centrifugation, filtration, or other process. Supernatant liquids frequently retain some suspended solids.

“Sludge” is a semi-solid slurry that can be produced from a range of industrial processes, from water treatment, or wastewater treatment. As water is removed from sludge, the percent dry matter increases, and the properties change from liquid-like to semi-solid to damp solid.

The indefinite articles “a” and “an” denote at least one of the associated noun and are used interchangeably with the terms “at least one” and “one or more.” For example, the phrase “a module” means at least one module, or one or more modules.

The conjunctions “or” and “and/or” are used interchangeably.

“About” or “approximately”, as used in this application, refers to ±20% of the recited value. However, due to difficulties in measuring pH accurately when pH is above 11, “about” indicates +/−0.3 pH units.

The term “aluminate” as used herein refers to various neutral or alkaline aluminum species such as alumina trihydrate (ATH), aluminum chloride, potassium aluminate, sodium aluminate, or aluminum hydro phosphate, calcium aluminate, or aluminum hydroxide, or the like.

The term “lime” as used herein refers to CaO, Ca(OH)₂, or the like.

The term “ettringite” as used herein refers to a slightly soluble compound comprising Ca, Al, and SO₄ having the approximate formula of Ca₆Al₂(SO₄)₃(OH)₁₂.26H₂O, as well as a series of chemically analogous compounds which form under the conditions disclosed herein.

### Overview

The present disclosure relates to methods for treating wastewater using lime and aluminate, and compositions relating to the same. One object of the disclosure is to produce treated water with reduced levels of contaminants such as sulfate, metals, and other undesirable species. Another object of the disclosure is to produce a precipitate which not only contains the contaminants removed from the water, but contains them in a form which remains substantially insoluble when subjected to environmental leaching, as may be determined by EPA Method 1311-TCLP (toxicity characteristic leaching procedure).

In certain aspects, a method of treating water or wastewater is provided, the method comprising mixing an amount of wastewater having less than approximately 2,000 ppm sulfate with an amount of lime in a container for at least approximately 60 minutes to generate a first mixture; and adding an amount of aluminate to the first mixture and mixing for at least approximately 60 minutes at a pH of approximately 11.3-12.5 to generate a second mixture, the second mixture comprising a solid portion and a liquid portion, wherein the solid portion comprises ettringite, and wherein total time in the container is referred to as a residence time. In some aspects, the first mixture may be allowed to settle precipitated solids, wherein the aluminate is then added to the supernatant.

In certain embodiments, the aluminate is selected from the group consisting of potassium aluminate, sodium aluminate, or aluminum hydro phosphate, calcium aluminate, or aluminum hydroxide. These may be commercially available products such as K-ALO-01-SOL, a liquid form of potassium aluminate, or NA-ALO-TG-P, a solid form of sodium aluminate, both available from American Elements Corporation, USALCO 38, a liquid form of sodium aluminate available from USALCO, or aluminum hydroxide (sometimes called alumina trihydrate or ATH), available in many grades from many suppliers, including Southern Ionics company, Sumitomo Chemical Company, Millipore-Sigma Corporation, or Wego Chemical Group. Suitable aluminate materials may also be prepared by dissolving an aluminum-containing precursor in alkali or acid, or by precipitating an aluminum-containing solution with base. The amphoteric nature of aluminum is well known. However, the aqueous chemistry of aluminum species is complex, both in terms of equilibrium and kinetics. The aluminate ion is often denoted by the formula AlO₂⁻, but the species in solution is more complicated. Thus, in some circumstances, it may be possible to substitute another aluminum-containing material for those listed, with appropriate minor modifications to the process herein described. The processes disclosed herein may be conducted on a batch or continuous basis.

In certain embodiments, the aluminate is added to the first mixture at a rate of approximately 22 lb/hour per 10 gpm wastewater flow, or 4,300 ppm. In some embodiments, the aluminate is added to the first mixture of approximately 10 lb/hour, 12 lb/hour, 14 lb/hour, 16 lb/hour, 18 lb/hour, 20 lb/hour, or 22 lb/hour. In a preferred embodiment, the aluminate is added to the first mixture at a rate of 22.4 lb/hour per 10 gpm wastewater flow, or per 600 gallons when operated in a batch mode.

In certain embodiments, the ratio of calcium to sulfate to aluminum is approximately 3:1-4:1 Ca:SO₄ and approximately 1:1 Al:SO₄.

In certain embodiments, the lime is hydrated lime.

In certain embodiments, the lime is added to the container at a rate of approximately 15 lb/hour by dry lime rate. In some embodiments, the lime is added to the container at a rate of approximately 16 lb/hour, 18 lb/hour, or 20 lb/hour by dry lime rate per 10 gpm wastewater flow.

In certain embodiments, the residence time is at least 60 minutes, or between approximately 240 minutes and 400 minutes. In some embodiments, the residence time is more than 240 minutes. In certain embodiments, the residence time is between 200 minutes and 300 minutes, between 300 minutes and 400 minutes, between 200 minutes and 400 minutes, or more than 100 minutes.

In some embodiments, a method of treating water or wastewater is provided, wherein the method comprises Stage I and Stage II, wherein the first stage (“Stage I”) comprises mixing wastewater having more than approximately 2,000 ppm SO₄²⁻ with lime in a container for at least about 70 minutes at a pH of approximately 11.5 to precipitate SO₄²⁻ to a level under approximately 2,000 ppm; and a second stage (“Stage II”) comprising: mixing wastewater from Stage I having less than approximately 2,000 or 2,500 ppm sulfate with lime in a container for approximately 60 minutes to generate a first mixture; and adding aluminate to the first mixture and mixing for approximately 60 minutes at a pH of approximately 11.3-12.5 to generate ettringite.

Also provided are compositions comprising a separated solid phase, such as a filter cake produced by a water or wastewater purification process, wherein the filter cake comprises SO₄ in an amount less than approximately 50% by weight on a dry weight basis.

In some embodiments, the filter cake comprises at least one of the metals selected from the group consisting of As, Ba, Cd, Cr, Pb, Hg, Se, and Ag (the “RCRA 8” metals) or one of the metals selected from the group consisting of Sb, Cu, Ni, TI, and Zn. In some embodiments, the filter cake comprises 2, 3, 4, 5, 6, or 7 metals selected from the group consisting of As, Ba, Cd, Cr, Pb, Hg, Se, and Ag. In certain embodiments, the filter cake comprises all of the Resource Conservation & Recovery Act (“RCRA”) 8 metals (i.e., As, Ba, Cd, Cr, Pb, Hg, Se, and Ag). In some embodiments, the filter cake may also comprise at least one of the metals selected from the group consisting of Sb, Cu, Ni, TI, and Zn.

### EXAMPLES

### Example 1: Sulfate and Trace Metals Precipitation

This example presents a summary of bench chemistry and field pilot testing for an aqueous sulfate removal process that effectively co-precipitates chloride and trace metals. This example represents a process engineering foundation for a risk mitigated process referred to herein as SaltOUT and a series of chemical products referred to herein as SaltOUT followed by product numbers.

Because the SaltOUT process removes large amounts of dissolved material, the SaltOUT chemistry necessarily generates large volumes of precipitated solids that require a special design for clarifiers and sludge processing. In a preferred embodiment, the Tonka Helicone™ clarifier optimally meets the solids contact and low-rise rate conditions that are beneficial for the SaltOUT process.

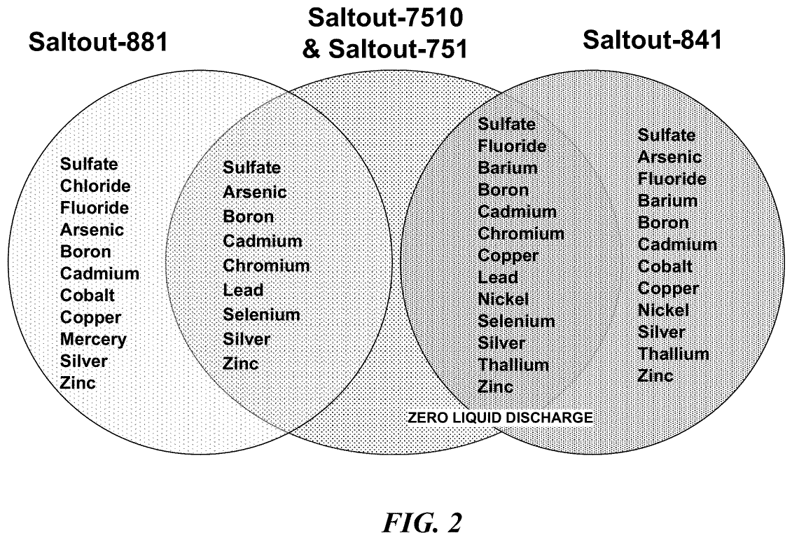

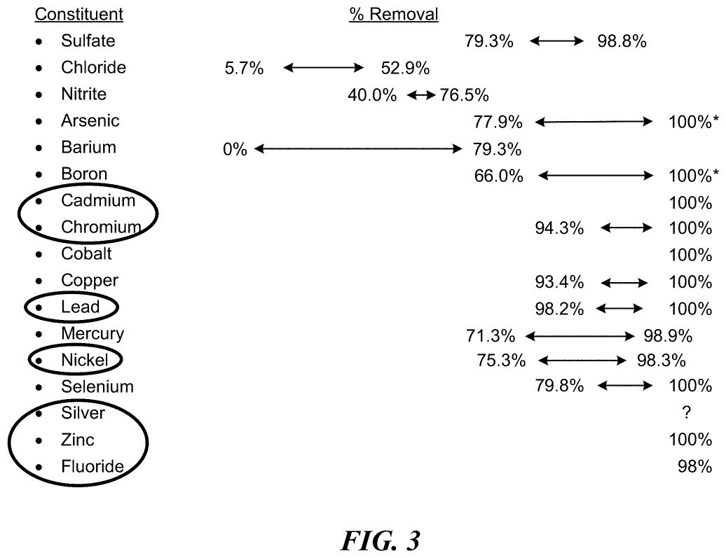

An additional feature of the SaltOUT process is the capture and ‘lockdown’ of trace metals in the dewatered sludge matrix. Trace metals capture can be measured by aqueous phase mass balance of sludge press feed and filtrate. Trace metals ‘lockdown’ is measured by EPA Method 1311-TCLP (toxicity characteristic leaching procedure) testing in the dewatered sludge for the “RCRA 8” metals (As, Ba, Cd, Cr, Pb, Hg, Se, and Ag). See FIGS. 2, 3.

Although the TCLP testing is limited, the RCRA 8 metals ‘lockdown’ is outstanding. Only barium shows some mobility and that mobility is well below preferred limits. Two toxic metals of concern, mercury and selenium, showed ‘no mobility’ (that is below analytical detection limit at <94 ppt and <9.1 ppb, respectively).

### SaltOUT as an ‘Ion Sink’

The SaltOUT process can be used with existing clarifiers, e.g., a Helicone™ clarifier. Alternatively, it may be practiced in open pits or ponds, or partitioned sections thereof, provided sufficient mixing and residence time. Alternatively, it may be practiced in a pipe, channel, ditch, etc., provided there is sufficient mixing and residence time. There are many potential applications of the SaltOUT process. Non-limiting examples include for any existing zero liquid discharge (ZLD) system with high sulfates. The SaltOUT process can also be used in precious metal mining with restrictive discharge permits or where high sulfates are limited in effluent or plant recycle water.

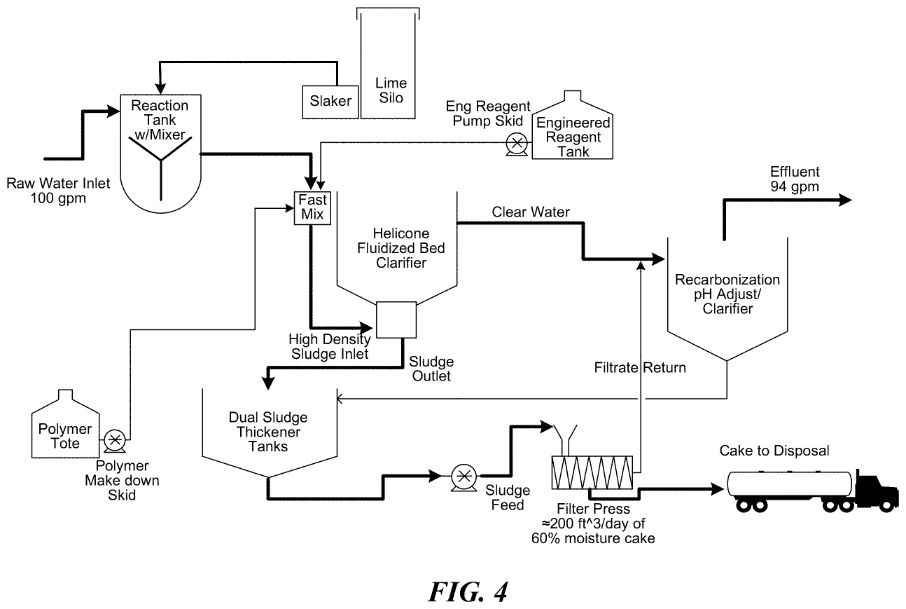

For example, the coal-fired segment of the U.S. utility industry will be retiring aging plants with high sulfate water ash ponds or FGD (flue gas desulfurization) basins. Both water sources may contain (toxic) trace metals. SaltOUT process knowledge combined with existing equipment can economically produce a permitted effluent with a co-product sludge suitable for landfill disposal. A schematic overview of a typical process flow diagram (PFD) for FGD basin treatment or similar applications is depicted in FIG. 4.

AMD (acid mine drainage) in active and abandoned coal mines has high sulfates and toxic trace metals. Environmental concerns about AMD began decades ago, vary by (State) enforcement initiatives, and have been critically underfunded. A reliable and economical AMD treatment system that ensures the fate of co-products can have wide application.

### SaltOUT Process

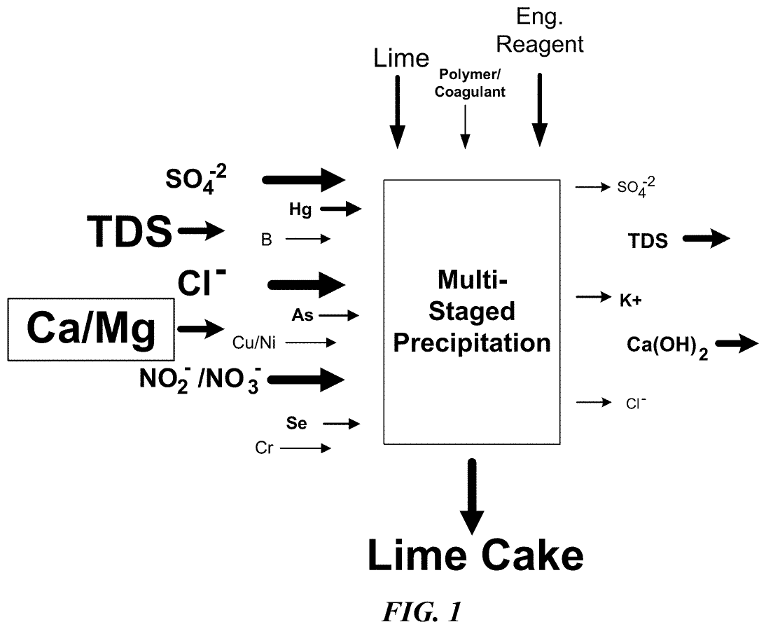

The following contains pertinent process information needed to remove sulfate and co-precipitate chlorides and trace metals. See FIG. 1. The sections are divided into the lab observations, pilot process data, and a TCLP (leachate) test data table.

Lab Observations. To examine the feasibility of a published method to remove sulfate, called Ultra High Lime Plus Aluminate, 1.5 g Na₂SO₄ (0.01 mol) was dissolved in 100 ml water and heated to 70 C. Lime (0.01 mol) was added gradually at 70 C, and the resulting mixture was cooled to 40 C. More lime (0.010 mol) and sodium aluminate (0.010 mol) were added incrementally over about 30 minutes with stirring, while controlling the pH at 12.2-12.6. After 15 minutes, the entire 100 ml had gelled. Centrifuging 8 ml samples of the gel for 5 minutes at 60,000 rpm, resulted in about 2.5 ml supernatant. The supernatant contained 1800 ppm SO₄, a reduction of 82%. This method was judged unacceptable because the produced sludge is intractable, and actually takes up a greater volume than the original wastewater. An improved process was required.

A key factor is the molar ratio of calcium to sulfate to aluminum. In principle, this is based on the molecular formula for ettringite. The formula for ettringite is as follows:

Ca₆Al₂(SO₄)₃(OH)₁₂.26H₂O

While ettringite is believed to be the desired precipitate, it may be that smaller amounts of other precipitates, such as calcium carbonate or aluminum hydroxide can form without seriously impairing overall performance. Acceptable ratio ranges may include approximately between 2:1 and 4:1 Ca:SO₄ and between 1:1 and 2:3 Al:SO₄.

According to the above formula, two moles of calcium are needed for each mole of sulfate, along with ⅔ of a mole of aluminum. However, unexpectedly it was found that the best sulfate removal results (+99%) are achieved with an excess of calcium in the final effluent water approaching 1,000 ppm as CaCO₃.

pH control is important to ettringite formation and efficient reagent utilization. A preferred pH for this reaction is 11.3-12.0. Depending on the application, a pH as high as 12.5 is acceptable. Other pH ranges include 11.5 to 12.0, 11.5 to 12.5, and 12.0 to 12.5.

By way of example, one typical recipe for a laboratory sulfate removal trial is as follows:
500 mL of FGD pond water @ 2,000 ppm SO₄⁻²
4.00 g hydrated lime (dry)
1.5 mL of a 38% sodium aluminate product (a ratio of 1:1 Al:SO₄)

Dry lime was added and stirred for 60 min for maximum calcium dissolution. Aluminate was then added and stirred for another hour. After 2 hours of mixing, 3 mL of a 0.5% solution of MegaFloc 4224 (a polymeric flocculant available from Kurita America) was added to flocculate the solids. After an hour of settling, the beaker was vacuum filtered through a qualitative filter disk. The filtrate was analyzed by IC/ICP.

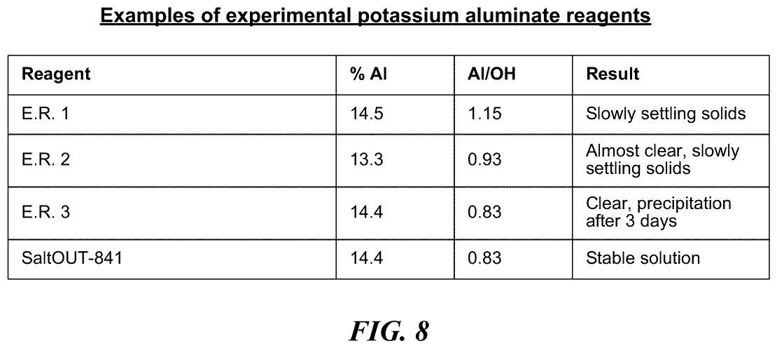

For some applications, potassium aluminate may be preferred, which is available as Kurita America SaltOUT-841 (approximately 12.5% weight Al). This product can be lab formulated from a mixture of potassium hydroxide and Dry Hydrate from Southern Ionics resulting in suspensions or solutions, as indicated in FIG. 8. The SaltOUT process uses the same sulfate to aluminum ratios with either potassium or sodium aluminate.

In a preferred embodiment, MegaFloc 4451 (a polymeric flocculant available from Kurita America) is the anionic flocculant for SaltOUT-841. Cationic flocculants may also work but can foul downstream membranes.

Lab Zero Liquid Discharge. In another example, for zero liquid discharge (ZLD) applications, another aluminum source is aluminum hydro phosphate. This product is made by mixing phosphoric acid with either source of aluminum hydroxide:
Dry 5 μm Al(OH)₃ (in this Example from Southern Ionics)
Al(OH)₃ ATH-H10 (in this Example from Wego Chemical Group)

These products are referred to as SaltOUT-751. The SaltOUT-751 may be mixed with phosphoric acid (referred to herein as SaltOUT-7510) and given 24 hours to mix. Without wishing to be bound by a particular theory, the following chemical reaction may occur upon mixing:

Al(OH)₃+H₃PO₄+H₂O↔Al(OH)₂⁺+H₂PO₄⁻+H₂O

For ≈75% aluminum activity, a mix ratio of 1:1 by weight of dry Al(OH)₃ to 75% H₃PO₄ is recommended. For complete aluminum activity, a higher acid ratio can be used. The acid-alumina mixture should be diluted to 5% with DI water and left to mix overnight or 12 hours.

One typical recipe for a laboratory sulfate removal trial is as follows:
500 mL of FGD pond water @ 2,000 ppm SO₄⁻²
Add 10% Lime slurry to pH 11.5; continuously stirred
Add 894 mg as dry Al(OH)₃ prepared by above specification (a ratio of 1.1:1 Al:SO₄)
Maintain a pH of ≈11.8 with lime slurry addition for approximately 2 hours

After fast mixing, 3 mL of 0.5% MegaFloc 4224 solution was slow mixed for ˜2-3 minutes. Settling was observed. After an hour of settling, the whole beaker was vacuum filtered through a qualitative filter disk. The supernatant may be analyzed by IC/ICP.

Note that there are no mono-valent or “conserved” ions added using aluminum hydro phosphate, and any excess phosphate is lime precipitated, so that the final dissolved solids are further reduced. While this method does not have the same SO₄ removal efficiency (80%) as soluble sodium or potassium aluminate, the treated water ionic strength (salt content) is lower as are the projected reagent costs. Lower ionic strength is often necessary where effluent discharge permits are mono-valent limiting.

High Strength Sulfate Precipitation. High strength sulfate streams are commonly encountered in the power and mining industry. These streams can range anywhere from 7,000 to 35,000 ppm SO₄²⁻. With these applications, a preliminary sulfate removal stage is often useful before the aluminate removal stage. This preliminary step is referred to as “Stage I”.

Multiple lab and pilot trials have been conducted on “Stage I” water, usually in the 7,000-8,000 ppm SO₄²⁻ range. The Stage I goal is to precipitate sulfate to <2,000 ppm, which is the solubility limit where lime stops removing sulfate.

Multiple lab tests showed that maximum practical SO₄ precipitation for “Stage I” water uses excess lime at a minimum pH of 11.5. Mixing at room temperature for at least 2 hours achieves precipitation believed to comprise gypsum before dosing with any coagulant and flocculant.

Once maximum reaction has been met, mixture may be dosed with approximately 200-300 ppm of neat aluminate solution in the sodium or potassium form. This serves to remove extra sulfate via the ettringite method as well as provide some coagulation of the slurry. After about 20 minutes of complete stirring, 20-40 ppm MegaFloc 4224 (an anionic emulsion polymer) was added for flocculation.

Pilot Observations.

To apply theoretical concepts like mole ratios to large operational treatment processes, it is necessary to convert to practical parameters like pounds per hour. By way of explanation, for water having 2000 ppm sulfate, one hour of flow at 10 gpm of would contain approximately 10 pounds (48 moles) sulfate. For a mole ratio of Al to SO₄ between 0.67 and 1.1, this requires between 35 and 52 moles of aluminum. For an aluminate reagent containing 13% Al, that is equal to between 14 and 24 pounds of reagent per hour.

Pilot testing was conducted with two different water streams from a coal-fired power plant. A large source was FGD Pond water, which contains approximately 1,900 ppm SO₄²⁻ plus various metals, such as barium, boron, mercury, nickel, selenium, and zinc. The FGD water stream was referred to as “Stage II” water due to its low strength. The key reagents used were hydrated lime; sodium aluminate at 38% (SaltOut-881) and anionic emulsion polymer (MegaFloc 4224).

A second water stream identified as “Bleed Pump Water” was a high strength stream with sulfate levels that varied from 15,000-29,000 ppm. Trace metals from coal combustion were high and variable.

The Bleed Pump Water was mixed with FGD Pond water at a 1:1 ratio in order to create “Stage I” water, which contained ≈7,800 ppm sulfate and a target of 10,000 μmhos. Mercury concentration in Stage I water was significant and measured at 29.1 ppb.

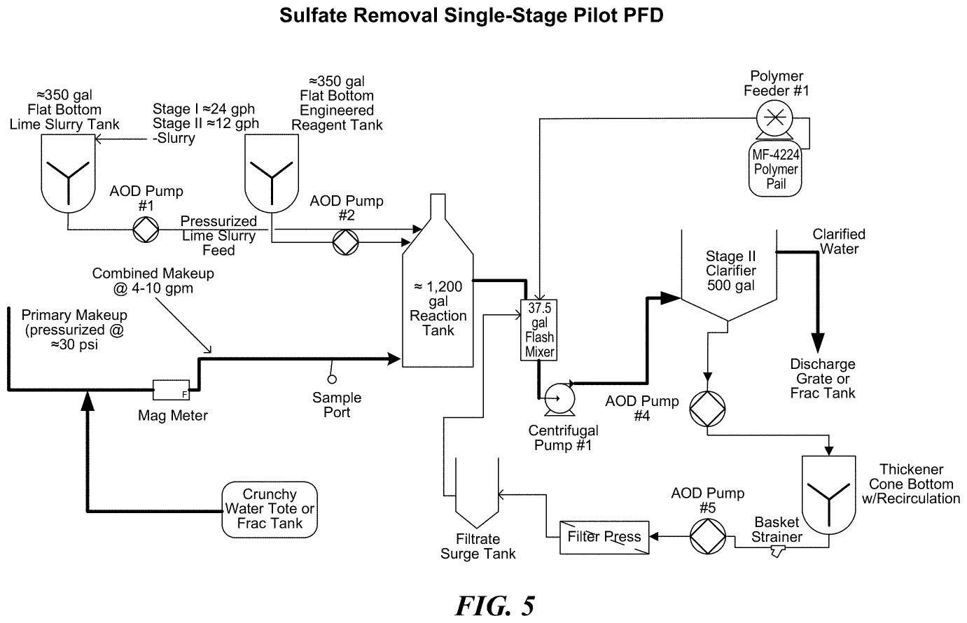

The pilot system was designed for a nominal flow rate of 10 gallons per minute. It consisted of a variable volume reaction tank with mixer, fast mix tank, cone-bottom clarifier, sludge thickener tank, and a plate and frame filter press. In addition, there were two reagent mix tanks for lime and aluminate, as well as dual polymer make-down skids. The makeup water for chemicals and cleaning was chlorinated river water, called “Service Water”. A schematic overview of sulfate removal in a single-stage pilot PFD is illustrated in FIG. 5.

Pilot Operation. As often occurs with pilot systems, extended ‘shakedown’ operation was necessary to achieve consistent results. After mixing was optimized to produce a homogeneous mixture with no separated zones of varying concentrations without disrupting the floc and clarifier entrance velocity was reduced, a ‘clean’ solids/liquid clarifier interface could be maintained at the design flow rate. It was surprisingly discovered that the rise rate of the clarifier, expressed as gallons per minute per square foot of clarifier cross-sectional area, should be between 0.15-0.5, and preferably between 0.25-0.3, to achieve best results. This is well below normal industry operating parameters of 0.8-1 gpm/ft².

Another challenge was achieving the correct ratio of lime to sulfate to alumina in the reaction tank at steady state. The residual soluble sulfate was analyzed in the reaction tank by filtering 1 mL through a 0.45 μm disk followed by the Hach SO₄ (turbidity) method. This field test has limitations but provides an ‘in-the-park’ indication of process efficiency for SO₄ removal.

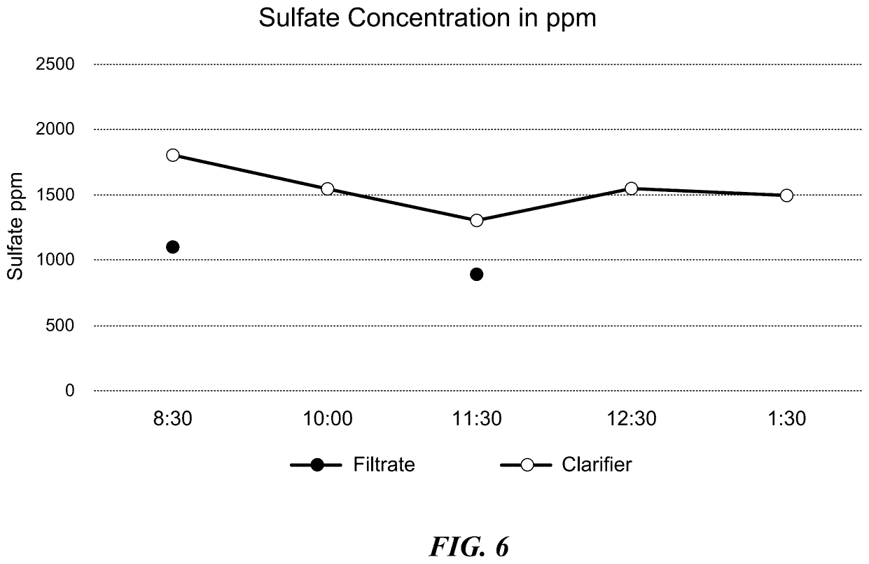

Stage I. The Stage I water contained approximately 7,800 ppm sulfate, where the goal was to precipitate that level to <2,000 ppm SO₄²⁻, and to maintain a minimum pH of 11.5 with mixing for a minimum of 70 minutes reaction time ⬆ with the lime fed based on mass flow. Results are shown in FIG. 6. Key process indicators (KPI) from Stage I Pilot Testing are summarized below in Table 1. Additional variables were measured and are quantified in Table 2.

TABLE 1
Pilot Testing Stage I KPIs

| Makeup water flow rate | 10 | gpm |
|---|---|---|
| Reaction tank residence time | † = 70-80 minutes | |
| Lime feed rate (dry basis) | 21 | lb/hr |
| Coagulant feed (SaltOUT-881) | 1.5 | lb/hr |
| Flocculant (MF-4224) | 33 | ppm |

TABLE 2
Stage I Analytical Data

| | Stage I | Stage I | Stage I |
|---|---|---|---|
| Sample system | Makeup | Filtrate | Clarifier |
| pH (units) | 6.24 | 11.6 | 11.5 |
| Conductivity (μmhos) | 10,090 | 2520 | 4,330 |
| Fluoride (ppm) | 33.0 | 14.7 | 4.01 |
| Chloride (ppm) | 311 | 293 | 246 |
| Sulfate (ppm SO₄) | 7,803 | 1,615 | 1,901 |
| Total Hardness (ppm as CaCO₃) | 5,379 | 1,945 | 2,247 |
| Ca Hardness (ppm as CaCO₃) | 1,110 | 1,936 | 2,239 |
| Mg Hardness (ppm as CaCO₃) | 4,269 | 8.68 | 8.08 |
| Aluminum (ppm) | 39.90 | 5.240 | 7.29 |
| Arsenic (ppb) | 63.0 | 13.9 | 13.0 |
| Barium (ppb) | 564 | 142 | 117 |
| Boron (ppb) | 6,820 | 3,020 | 2,320 |
| Cadmium (ppb) | 4.1 | ND | ND |
| Chromium (ppm as Cr) | 118 | 6.7 | 5.3 |
| Cobalt (ppb) | 39.5 | ND | ND |
| Copper (ppb) | 193 | 12.2 | 12.7 |
| Iron (ppm as Fe) | 5.95 | <0.10 | <0.10 |
| Lead (ppb) | 61.8 | 1.1 | ND |
| Manganese (ppm) | 15.1 | <0.05 | <0.05 |
| Mercury (ng/L) | 29,100 | 37.0 | 319 |
| Nickel (ppb) | 393 | ND | ND |
| Potassium (ppm) | 19.2 | 16.5 | 17 |
| Selenium (ppb) | 426 | 98.6 | 85.9 |
| Silica (ppm) | 131 | 2.30 | 2.28 |
| Silver (ppb) | ND | ND | ND |
| Sodium (ppm) | 104 | 132 | 139 |
| Strontium (ppm) | 2.1 | 1.89 | 1.83 |
| Thallium (ppb) | 1.7 | 0.46 | 0.79 |
| Zinc (ppb) | 570 | 8.4 | ND |
| Bold Indicates Low Level | 2 Aug. 18 | 2 Aug. 18 | 2 Aug. 18 |
| Test Procedure EPA 200.8 | | | |

Stage II. The Makeup water for Stage II is FGD Pond water with a starting point of ≈2,000 ppm. The Stage II focus became reagent feed accuracy and increased Residence Time. This allowed reliable sulfate reduction and consistent sulfate levels <250 ppm in the clear water of the clarifier. Low suspended solids, low sulfate effluent was achieved for over 4 hours. The key became managing the interaction between reaction, thickening, filter cake production, clarification, and sludge wasting.

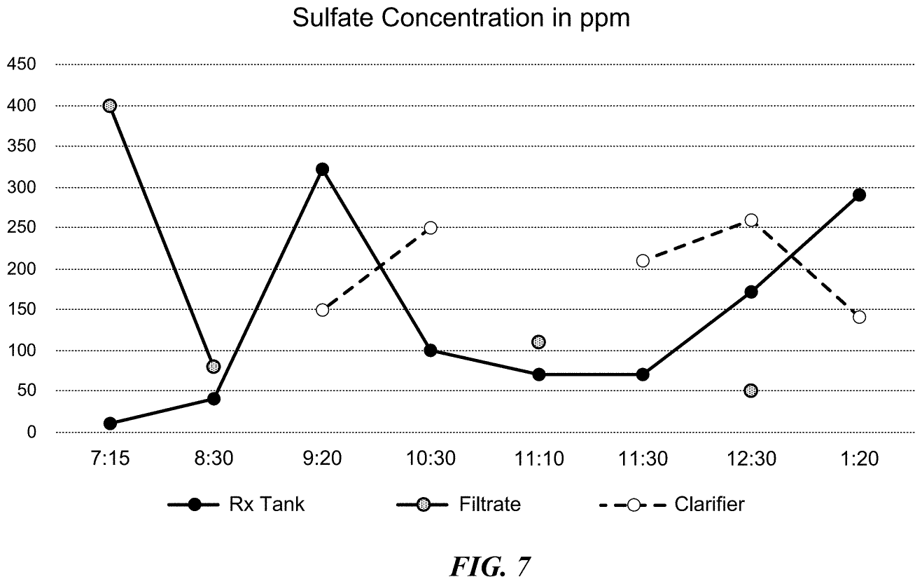

Process variables (for example, reagent feed rate, pH, residence time, inlet velocity, sludge wasting, etc.) have an operating “window” that allows production of low turbidity and low-sulfate water. Sulfate concentration in ppm for Stage II is quantified in FIG. 7. Pilot Testing Stage II KPIs are summarized below in Table 3. Additional variables were measured and are quantified in Table 4.

TABLE 3
Pilot Testing Stage II KPIs

| Makeup water flow rate | 10 | gpm |
|---|---|---|
| Reaction tank residence time | † = 60 minutes | |
| Lime feed rate (dry basis) | 15 | lb/hr |
| Coagulant feed (SaltOUT-881) | 22.4 | lb/hr |
| Flocculant (MF-4224) | 32 | ppm |

TABLE 4
Stage II Analytical Data

| | FGD | FGD | FGD |
|---|---|---|---|
| Sample system | Makeup | Filtrate | Effluent |
| pH (units) | 5.23 | 12.3 | 12.2 |
| Conductivity (μmhos) | 3,000 | 12,510 | 10,240 |
| TSS (ppm) | 4 | 3.5 | 27 |
| Chloride (ppm) | 51.4 | 28.3 | 28.9 |
| Sulfate (ppm SO₄) | 1896 | 22.5 | 233 |
| T. Hard (ppm as CaCO₃) | 1978 | 927 | 543 |
| Ca (ppm as CaCO₃) | 1329 | 927 | 542 |
| Mg (ppm as CaCO₃) | 649 | <0.50 | 1.27 |
| Arsenic (ppb) | 2.2 | ND | ND |
| Barium (ppb) | 52.3 | 150 | 82.8 |
| Boron (ppb) | 1,760 | ND | ND |
| Cadmium (ppb) | ND | ND | ND |
| Chromium (ppm as Cr) | ND | ND | ND |
| Cobalt (ppb) | 0.36 | ND | ND |
| Copper (ppb) | 5.9 | ND | 1.4 |
| Iron (ppm as Fe) | <0.10 | <0.25 | <0.10 |
| Lead (ppb) | 2.2 | 5.7 | ND |
| Mercury (ng/L) | 52.3 | 15 | 6.61 |
| Nickel (ppb) | 16.8 | 5.5 | 5.0 |
| Potassium (ppm) | 5.82 | 9.79 | 10.9 |
| Selenium (ppb) | 11.7 | 2.4 | 2.7 |
| Sodium (ppm) | 33.8 | 986 | 666 |
| Strontium (ppm) | 2.03 | 2.43 | 1.97 |
| Thallium (ppb) | 0.12 | 0.076 | 0.057 |
| Zinc (ppb) | 14.3 | ND | ND |
| Bold Indicates Low Level | 12 JUL. 18 | 12 JUL. 18 | 25 JUL. 18 |
| Test Procedure EPA 200.8 | | | |

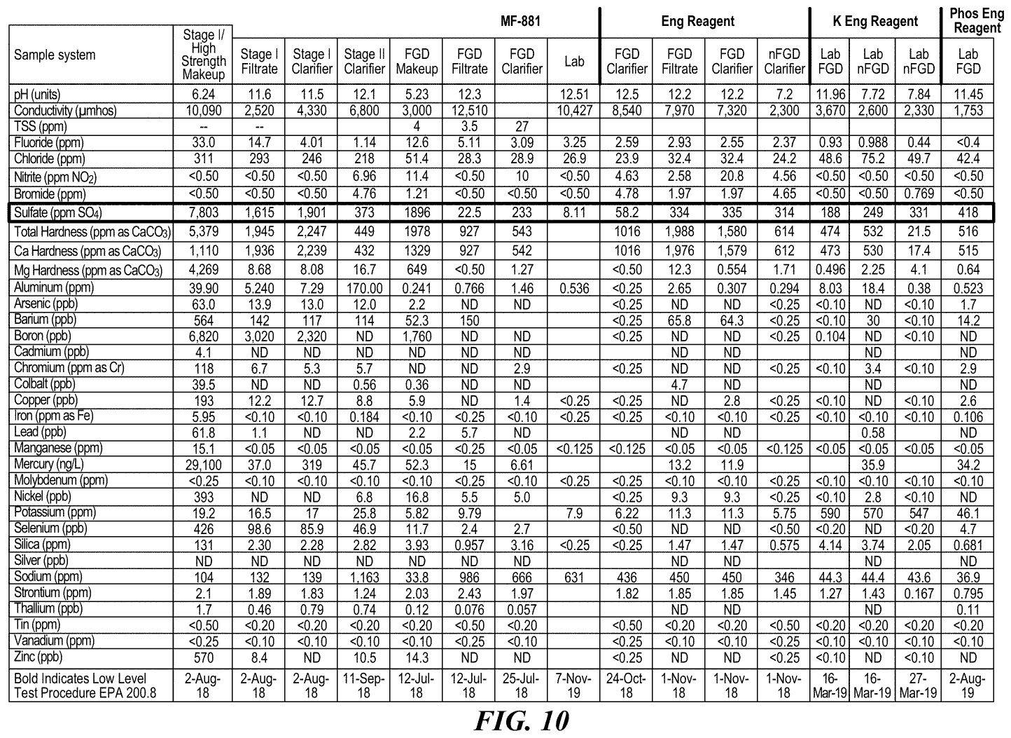

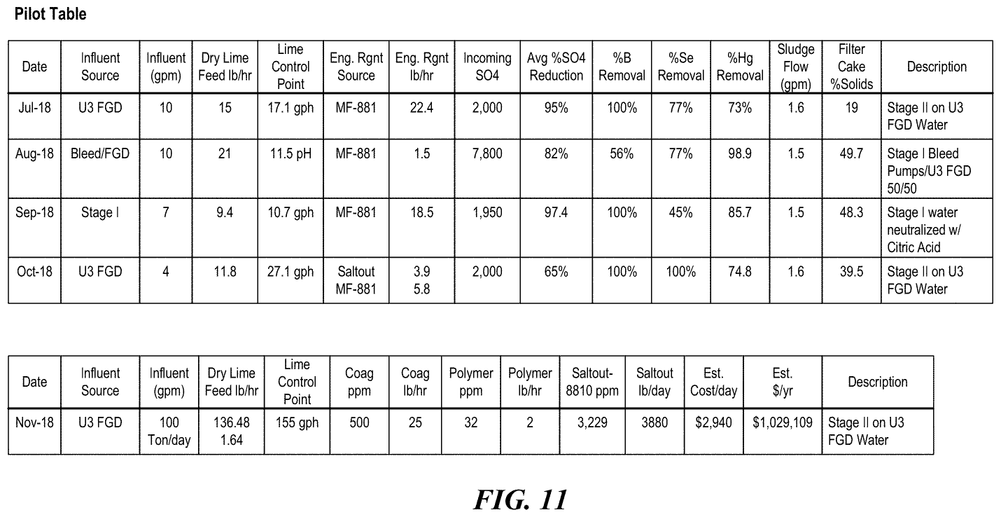

One important KPI for low level removal of sulfate was discovered during post-pilot analysis and confirmed in lab batches. A factor for complete ettringite formation is the presence of a healthy calcium residual in the water. Subsequent lab work determined that an excess of 1,250 ppm Ca as CaCO₃ produced a final sulfate residual of 8.1 ppm. These results can also be achieved in a pilot or commercial application. See FIGS. 10, 11.

Unexpectedly, the capture and ‘lockdown’ of trace metals—especially selenium, boron, arsenic, and chromium—were discovered as a result of the processes described herein.

Pilot Sludge Handling. Although water discharge quality is the goal of the sulfate precipitation, the handling of the Stage II sludge is a major factor in any commercialized process. Not only is sludge handling a necessary “by product” of any precipitation process, but findings indicate that it can affect final water quality. The pilot tests showed that the sulfate level in the decanted sludge thickener (‘aged’ overnight) was lower than the clarified water. This repeatable data shows that the thickener is also a secondary reaction vessel that improves reagent utilization and final effluent.

This finding encouraged addition of the decant water from the equalization tank to the clarification process. When the filter press operated, the filtrate slugs were added to an equalization tank and slowly bled back into the fast mix tank. Any reagent or sulfate excess would then react in the clarifier and improve overall efficiency. The pilot tests also showed that recycling sludge from the thickener to the clarifier resulted in faster and more complete removal. The recycle can originate from the thickener or the filter press and can be recycled to the reaction tank or clarifier. Without wishing to be bound by theory, this may be analogous to the “heel” employed in crystallization processes.

It should be noted that, in contrast to typical solid-liquid separation processes, no polymer feed was needed in the thickener tank to aid in the dewatering process as the ettringite reaction seems to have a coagulation effect. Any excess polymer in the thickener tank upset the balance in the clarifier upon recycle of filtrate. There was little additional benefit to the filtration process. A 30 ppm polymer feed rate to the fast mix tank was sufficient for the entire process.

While Stage I Bleed Pump water is very specific to FGD processes in the power industry, any high strength water streams may be pilot tested for sludge processing by one skilled in the art in accordance with the disclosure herein.

Stage I Sludge Handling. The pilot testing inlet makeup water for Stage I was 10 gpm average with approximately 0.5 gpm of sludge flow from the system. The sludge consisted of approximately 2.43 lb of dry solids per gallon of sludge and the filter cake was 49.65% Moisture. The 0.5 gpm sludge flow was the minimum necessary volume in order to maintain flow and not plug the clarifier. The filter cake solid test results are as follows:
Trial #1: 51.6% solids
Trial #2: 47.7% solids

Stage II Sludge Handling. The pilot testing inlet makeup water rate for the FGD Pond water was 10 gpm with approximately 1.6 gpm sludge removal from the clarifier needed to maintain fluid flow. Each press batch produced approximately 125 lb of 19.6% Solids where each press batch requires about 40 gallons of thickened sludge.

The typical clarifier feed water settling rates on Stage II slurry is presented in Table 5 below. Lower values denote improved settling.

TABLE 5
Settling Rate (Stage II Slurry)
Jul. 12, 2018 Rapid Mix Samples

| | |
|---|---|
| Elapsed Time | Sludge Blanket Level (mL) |

| (minutes) | 10:22 AM | 11:29 AM |
|---|---|---|
| 0 | 4000 | 4000 |
| 5 | 3375 | 2300 |
| 10 | 2600 | 1750 |
| 15 | 2200 | 1450 |
| 20 | 1950 | 1300 |
| 25 | 1800 | 1200 |
| 30 | | 1150 |

Percent moisture in filter press cakes is quantified in Table 6. Without wishing to be limited by theory, the greater amount of “bound water” in the Stage II filter cake may be responsible for the improved sequestration and lockdown of the RCRA metals.

TABLE 6
Filter Press Cake Results

| Date | | Trial # | % Moisture |
|---|---|---|---|
| 10 JUL. 2018 | Stage II | 1 | 80.8 |
| 10 JUL. 2018 | Stage II | 2 | 80.4 |
| 25 JUL. 2018 | Stage II | 1 | 80.3 |
| 25 JUL. 2018 | Stage II | 2 | 80.3 |
| 2 AUG. 2018 | Stage I | 1 | 48.4 |
| 2 AUG. 2018 | Stage I | 2 | 52.3 |
| 11 SEP. 2018 | Combined | 1 | 47.2 |
| 11 SEP. 2018 | Combined | 2 | 56.3 |

### Leachate Characteristics of Filter Cake.

One important factor in choosing a cost-effective treatment plan is the ‘fate’ or long-term viability of the filter solids. Simply put, if the metals that were once captured in the sludge readily leach back into the environment, the process may have little benefit. For example, U.S. Pat. No. 5,547,588 states that ettringites containing borates or selenates will dissolve incongruently into aluminum-rich solids and dissolved components. Furthermore, metal hydroxides, which will form at high pH, are known to dissolve when the pH is reduced, as in the TCLP test.

TCLP tests were conducted on filter cake that was produced during a sludge pilot on a power boiler scrubber water. This sludge dewatering pilot did evaluate slow reacting calcium aluminate for sulfate reduction. Powdered calcium aluminate was eventually replaced by more reactive reagents. However, there was value in gathering TCLP data from these sludge samples.

Sample Identification. as follows:
Sample 1 Cake: Representation of Stage I Sludge Cake
   Lime Only
Sample 2 Cake: Stage I sludge with ash present
   Lime plus fly ash
Sample 3—10%: Mixture of Stage II with Stage I @ nominal 10% by volume
   Lime plus calcium aluminate
Sample 3—20/80: Mixture of Stage II with Stage I @ nominal 20% by volume
   Lime plus calcium aluminate

Test Procedure. Toxicity Characteristics Leaching Procedure (TCLP) is designed to determine the mobility of the organic & inorganic analytes present in liquid, solid, or multiphase wastes. TCLP is the ‘gatekeeper test’ for landfill managers. When the SaltOUT process is commercially installed, understanding the environmental fate of the precipitation co-products is important.

EPA 1311 is the method used for TCLP, and the procedure generates extraction fluid from a solid sample by adding a glacial acetic acid solution to the sample at approximately 20% by weight; then agitating the container for 18 hours. Leaching properties of the four samples described above were tested and leaching results are presented in Table 7 below. TCLP results for phase II are depicted in Table 8 below.

TABLE 7
Leaching Results

| | Sample | Sample | Sample | Sample |
|---|---|---|---|---|
| | 1 | 2 | 3 - 10% | 3 - 20/80 |
| Arsenic (mg/L) | <0.034 | <0.034 | <0.034 | <0.034 |
| Barium (mg/L) | <0.079 | 0.23 | <0.079 | 0.23 |
| Cadmium (mg/L) | <0.0011 | <0.0011 | <0.0011 | <0.0011 |
| Chromium (mg/L) | <0.0046 | <0.0046 | <0.0046 | <0.0046 |
| Lead (mg/L) | <0.0091 | <0.0091 | <0.0091 | <0.0091 |
| Mercury (μg/L) | <0.094 | <0.094 | <0.094 | <0.094 |
| Selenium (mg/L) | <0.0091 | <0.0091 | <0.0091 | <0.0091 |
| Silver (mg/L) | <0.051 | <0.051 | <0.051 | <0.051 |
| Sulfate (mg/L) | 575 | 1,190 | 748 | 625 |

TABLE 8
Phase II TCLP Results for Sulfate Pilot 2018 Filter Cake

| | 25 JUL. | 2 AUG. | 11 SEP. | 31 OCT. |
|---|---|---|---|---|
| | 2018 | 2018 | 2018 | 2018 |
| Initial pH | 12.19 | 10.17 | 10.33 | 12.32 |
| Antimony (μg/L) | <100 | <100 | <100 | <100 |
| Arsenic (mg/L) | <0.50 | <0.50 | <0.50 | <0.50 |
| Barium (mg/L) | <1.0 | <1.0 | <1.0 | <1.0 |
| Cadmium (mg/L) | <0.05 | <0.05 | <0.05 | <0.05 |
| Chromium (mg/L) | <0.50 | <0.50 | <0.50 | <0.50 |
| Copper (μg/L) | <100 | <100 | <100 | <100 |
| Lead (mg/L) | <0.50 | <0.50 | <0.50 | <0.50 |
| Nickel (μg/L) | <100 | 107 | <100 | <100 |
| Mercury (μg/L) | <0.60 | <0.60 | 0.81 | 0.81 |
| Selenium (mg/L) | <0.1 | <0.1 | <0.1 | <0.1 |
| Silver (mg/L) | <0.10 | <0.10 | <0.10 | <0.10 |
| Sulfate (mg/L) | 1,360 | 1,420 | 2.7 | 14.8 |
| Thallium (μg/L) | <100 | <100 | <100 | <100 |
| Zinc (μg/L) | <500 | <500 | <500 | <500 |
| Final pH | 9.77 | 6.56 | 7.61 | 11.31 |

Sample descriptions for the data presented in Table 8 are as follows (where *Refers to a 38% sodium aluminate solution (SaltOUT-881)):
25 Jul. 2018 FGD Pond water treated as Stage II
   2,995 ppm Lime and 4,473 ppm*NaAlO₂
2 Aug. 2018 High Strength, 50/50 bleed water treated as Stage I
   4,194 ppm Lime and 300 ppm NaAlO₂
11 Sep. 2018 Stage II water using Treated Stage I effluent as feed
   2,682 ppm Lime and 5,278 ppm NaAlO₂
31 Oct. 2018 FGD Pond water treated as Stage II
   5,892 ppm Lime, 1,948 Al(OH)₃ and 2,897 ppm NaAlO₂

From these examples it can be seen that the solid produced by the methods disclosed here is highly resistant to leaching, and releases little if any of the toxic compounds removed from the treated wastewater.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method of treating water comprising:
mixing a first water or wastewater having between about 500 ppm and about 2,500 ppm sulfate with an amount of lime for at least about 60 minutes to generate a first mixture;
mixing an amount of aluminate and the first mixture for at least about 60 minutes at a pH of about 11.3 to 12.5 to generate a second mixture, the second mixture comprising ettringite, wherein the aluminate is selected from the group consisting of potassium aluminate, sodium aluminate, aluminum hydro phosphate, aluminum chloride, aluminum chlorohydrate, calcium aluminate, alumina trihydrate or aluminum hydroxide, and combinations thereof; and
separating the second mixture into a sludge and a supernatant liquid portion, wherein the sludge comprises ettringite.

2. The method of claim 1, further comprising:
thickening the sludge to form a thickened sludge and a supernatant; and
further processing the thickened sludge or supernatant to form a separated solid portion and a supernatant.

3. The method of claim 1, wherein separating the second mixture further comprises separating the second mixture in a clarifier having a rise rate of between about 0.15 and 0.4 gallons per minute per square foot of a cross-sectional area of the clarifier.

4. The method of claim 1, wherein separating the second mixture further comprises separating the second mixture in a clarifier having a rise rate of between about 0.25 and 0.3 gallons per minute per square foot of a cross-sectional area of the clarifier.

5. The method of claim 1, wherein separating the second mixture further comprises separating the second mixture in a clarifier having an entrance velocity sufficient to induce centrifugal separation.

6. The method of claim 2, further comprising recycling at least a part of the supernatant liquid from the step of processing the thickened sludge to the process.

7. The method of claim 2, further comprising recycling at least a part of the sludge, thickened sludge, or separated solid portion to the clarifier.

8. The method of claim 2, wherein the step of thickening the sludge is substantially free of polymer added subsequent to the step of separating the second mixture.

9. The method of claim 1, wherein the mixing is sufficient to substantially prevent separated zones of varying concentrations in the first mixture.

10. The method of claim 1, wherein the ratio of calcium to sulfate is between about 2 to 1 and 4 to 1, and the ratio of aluminum to sulfate is between about 1.1 to 1 and 2 to 3.

11. The method of claim 10 where an amount of excess soluble calcium during mixing is maintained at about 500 to 2000 ppm.

12. The method of claim 1, further comprising adding the amount of lime at a rate to maintain approximately 4,000 ppm by dry lime weight.

13. The method of claim 1, further comprising adding the amount of lime at a constant rate by mass.

14. The method of claim 1, wherein the lime is added at a rate to maintain the pH of about 11.3 to 12.5.

15. The method of claim 1, further comprising adding the amount of aluminate to the first mixture at a rate to maintain approximately 0.19 to 0.31 ppm Al per ppm sulfate to be removed.

16. The method of claim 1, further comprising mixing a second wastewater having more than approximately 2,000 ppm SO₄²⁻ with lime for at least about 70 minutes at a pH of approximately 11.5 to precipitate SO₄²⁻ to a level under approximately 2,000 ppm to form a third wastewater, and adding about 200 to 300 ppm of aluminate to the third wastewater to form the first wastewater.

17. The method of claim 2, wherein the separated solid portion comprises at least one of the metals selected from the group consisting of As, Ba, Cd, Cr, Pb, Hg, Se, Ag, Sb, Cu, Ni, TI, and Zn that exhibits retarded dissolution in the separated solid portion as measured by EPA Method 1311-TCLP.

18. A method of treating water comprising:
mixing a first wastewater having between about 500 ppm and about 2,000 ppm sulfate with an amount of lime for at least about 60 minutes to generate a first mixture;
mixing an amount of aluminate and the first mixture for at least about 60 minutes at a pH of about 11.3 to 12.5 to generate a second mixture, the second mixture comprising ettringite, wherein the aluminate is selected from the group consisting of potassium aluminate, sodium aluminate, aluminum hydro phosphate, aluminum chloride, aluminum chlorohydrate, calcium aluminate, alumina trihydrate or aluminum hydroxide, and combinations thereof;
separating the second mixture into a sludge and liquid portion, wherein the sludge comprises ettringite;
thickening the sludge to form a thickened sludge; and
processing the thickened sludge to form a separated solid portion comprising at least one of the metals selected from the group consisting of As, Ba, Cd, Cr, Pb, Hg, Se, Ag, Sb, Cu, Ni, TI, and Zn that exhibits retarded dissolution in the separated solid portion as measured by EPA Method 1311-TCLP.

19. A method of treating water comprising:
mixing a first wastewater having between about 500 ppm and about 2,500 ppm sulfate with an amount of lime at a rate to maintain a pH of about 11.3 to 12.5 for at least about 60 minutes to generate a first mixture;
mixing an amount of aluminate and the first mixture for at least about 60 minutes at to generate a second mixture, the second mixture comprising ettringite, wherein the aluminate is selected from the group consisting of potassium aluminate, sodium aluminate, aluminum hydro phosphate, aluminum chloride, aluminum chlorohydrate, calcium aluminate, alumina trihydrate or aluminum hydroxide, and combinations thereof, the ratio of calcium to sulfate is between about 6 to 3 and 8 to 2, the ratio of aluminum to sulfate is between about 1.1 to 1 and 2 to 3, and the amount of excess soluble calcium is maintained during mixing at about 500 to 2000 ppm;
separating the second mixture into a sludge and liquid portion in a clarifier having a rise rate of between about 0.254 and 0.3 gallons per minute per square foot of a cross-sectional area of the clarifier, wherein the sludge comprises ettringite;
thickening the sludge to form a thickened sludge; and
processing the thickened sludge to form a separated solid portion comprising at least one of the metals selected from the group consisting of As, Ba, Cd, Cr, Pb, Hg, Se, Ag, Sb, Cu, Ni, TI, and Zn.
wherein the method is operated on a continuous basis.

20. The method of claim 19, further comprising recycling at least a part of the sludge, thickened sludge, or separated solid portion to the clarifier.
